(19) United States
(12) Patent Application Publication
(10) Pub. No.: US 2020/0213368 A1
(43) Pub. Date: Jul. 2, 2020

(54) Interactive Intelligent Educational Board and System

(71) Applicant: Mega Visions Boards, Inc., Rialto, CA (US)

(72) Inventors: Rafael Rangel, Rialto, CA (US); Carlos Anguiano, Riverside, CA (US); Aldo Silva, Tijuana (MX); Jaime Hernandez, Rialto, CA (US)

(73) Assignee: Mega Vision Boards, Inc., Rialto, CA (US)

(21) Appl. No.: 16/729,105

(22) Filed: Dec. 27, 2019

Related U.S. Application Data
(60) Provisional application No. 62/785,682, filed on Dec. 27, 2018.

(51) Int. Cl. H04L 29/06; G09B 5/06

(52) U.S. Cl. CPC H04L 65/4015; G09B 5/065; H04L 65/4053

(57) ABSTRACT

An interactive video board allows creation of a virtual classroom that enables real-time audio-visual communication and a real-time exchange of digital information between students in a physical classroom and a remote student at a location outside the physical classroom. The interactive video board includes a central processing unit (CPU) and a physical storage device that stores machine-executable instructions through which the CPU controls operation of the interactive video board. The video board also includes a multitouch display device that itself includes both (a) a video display device, which drives the presentation of graphical information (including streamed audio/visual data in some embodiments) to the students in the physical classroom, and (b) a multitouch input screen configured to capture, in response to a student's touching the screen, graphical input data for display on the video display device in the physical classroom and on a remote device used by the remote student. The video board also includes (c) audio and video capture devices that create audio and video data from activities in the physical classroom for delivery to the remote device and (d) a remote-connectivity component coupled to an external network to effect delivery of the graphical input data and the audio and video data from the interactive video board to the remote device.

### CROSS-REFERENCE TO RELATED APPLICATION

This application claims benefit of priority to U.S. Provisional Patent Application No. 62/785,682, filed on Dec. 27, 2018, entitled “Interactive Intelligent Educational Board,” the entire disclosure of which is incorporated by reference herein.

### FIELD OF DISCLOSURE

This application relates to a device, a system, and corresponding methods for enabling connectivity of teacher and students in a physical classroom with one or more remote students at locations outside the classroom.

### BACKGROUND

From the ashes used to create the first cave painting to electronic screen-capture tablet writings many millennia later, communication, presentation, and education tools have evolved. In the pioneer days, when access to paper was limited, children would do their school assignments on a small chalk board they would take home each day. As the years passed, availability and accessibility to educational material increased to the point that children no longer needed to be in a traditional classroom to interact with educational material and instruction.

In today's world, some devices to facilitate education are designed to either provide one-way interaction between teacher to student or student to teacher. Others allow for some amount of two-way communication, but full participation by a remote student in classroom activities has remained out of reach.

### SUMMARY

Described below is an interactive video board for use in effecting a virtual classroom that enables real-time audio-visual communication and a real-time exchange of digital information between students in a physical classroom and a remote student at a location outside the physical classroom. In preferred embodiments, the interactive video board includes a central processing unit (CPU) and a physical storage device that stores machine-executable instructions through which the CPU controls operation of the interactive video board. The video board also includes a multitouch display device that itself includes both (a) a video display device, which drives the presentation of graphical information (including streamed audio/visual data in some embodiments) to the students in the physical classroom, and (b) a multitouch input screen configured to capture, in response to a student's touching the screen, graphical input data for display on the video display device in the physical classroom and on a remote device used by the remote student. The video board also includes (c) audio and video capture devices that create audio and video data from activities in the physical classroom for delivery to the remote device and (d) a remote-connectivity component coupled to an external network to effect delivery of the graphical input data and the audio and video data from the interactive video board to the remote device.

In some embodiments the interactive video board also includes system-monitoring and remote-control components. The system-monitoring component collects data about operation of interactive video board components for delivery to an external system monitoring service, and the remote-control component allows a user of the interactive video board to cede operational control of the interactive video board to a remote technical-support service.

In certain embodiments of the interactive video board, the remote-connectivity component is also configured both to receive from the remote device additional graphical input data created by the remote student and to deliver the additional graphical input data for display by the video display device in the physical classroom. For some of these embodiments, the video board also includes an audio output device, and the remote-connectivity component device is configured to receive from the remote device additional audio and video data captured by the remote device and to deliver the additional audio and video data for display by the video display and the audio output device in the physical classroom.

### BRIEF DESCRIPTION OF THE DRAWINGS

FIG. 1 is a high-level diagram of a computerized system for enabling a “virtual classroom” that connects a teacher and students in a physical classroom (through an interactive intelligent video board called Escribano™) with one or more students in remote locations or even present in the physical classroom (through tablet computers or other suitable computer devices) through a cloud-enabled network that includes a Mega Vision™ brand network-connectivity infrastructure and an audio-visual connectivity service.

FIG. 2 is a diagram showing network-infrastructure components, including a Mega Meetings™ brand network connectivity service, that enable connection of teacher and students in the physical classroom with remote students through a virtual classroom.

FIG. 3 is a diagram showing the computer system components (including the Miros™ brand control software) that embody and enable the interactive intelligent video board in the physical classroom.

FIG. 4 is a diagram showing interaction of the Miros™ brand control software with other system components of the intelligent video board.

FIG. 5 is a flow diagram showing a method, carried out by the Mega Meetings™ network-connectivity service in conjunction with the Escribano™ intelligent video board, for allowing the teacher in a physical classroom to establish a virtual classroom, enable remote students (or physically present students) to connect to the virtual classroom, and interact with the remote students (or physically present students) through the virtual classroom.

FIG. 6 is a flow diagram showing a method, carried out by the Mega Meetings™ network-connectivity service in conjunction with the Escribano™ intelligent video board, for allowing the teacher to create virtual classroom registries and populate the registries with students allowed to participate in the virtual classroom.

FIG. 7 is a flow diagram showing a method, carried out by the Mega Meetings™ network-connectivity service in conjunction with the web browser application of a remote computer device, for allowing the parent/guardian of a remote student to access class information.

FIG. 8 is a flow diagram showing a method, carried out by the Mega Meetings™ network-connectivity service in conjunction with the web browser application of a remote computer device, for allowing a remote student (or student physically present in the classroom) to connect to a virtual classroom and interact with teacher and students in a physical classroom.

FIG. 9 is a flow diagram showing a boot-up sequence for the interactive intelligent video board.

### DETAILED DESCRIPTION

The following detailed description is merely exemplary in nature and does not limit the disclosure or the application and uses of the invention. As used here, the word “exemplary” means “serving as an example, instance, or illustration.” Thus, any embodiment described here as “exemplary” is not necessarily to be construed as preferred or advantageous over other embodiments. Furthermore, there is no intention to be bound by any expressed or implied theory presented in the preceding technical field, background, brief summary, or the following detailed description.

The following description is presented to enable any person skilled in the art to make and use the invention, and is provided in the context of a particular application and its requirements. Various modifications to the disclosed embodiments will be readily apparent to those skilled in the art upon reading this disclosure, and the general principles defined herein may be applied to other embodiments and applications without departing from the spirit and scope of the invention. Thus, the invention is not intended to be limited to the embodiments shown, but it is to be accorded the widest scope consistent with the principles and features disclosed herein.

Described here are a device and system that (a) allow a teacher in a physical classroom to establish a virtual classroom that effects interaction between students in the physical classroom and students at remote locations and (b) provide an interface through which the remote students can participate in all aspects of classroom activity. The system allows participants in the physical classroom and the remote students to see and hear each other through video and audio connectivity and to share and fully participate in the creation of written content through a virtual classroom whiteboard. The system also allows parental supervision of classroom information and activities and provides real-time system monitoring, diagnostics, and user support through a connected support feature.

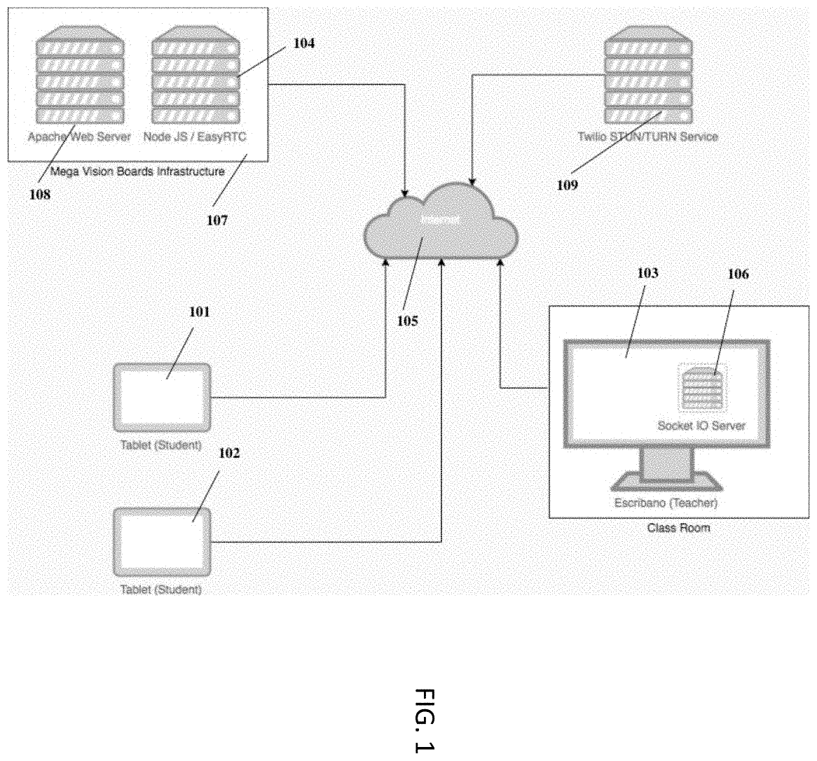

FIG. 1 is a high-level diagram of a system for effecting a “virtual” classroom that creates a connection for a teacher and students in a physical classroom with remote students at locations outside the physical classroom, allowing full participation in classroom activities by the remote students. The system includes: An interactive intelligent video board 103 (called Escribano™ in preferred embodiments), which resides in the physical classroom and serves as the primary interface for the teacher and students there; one or more remote tablet computers 101, 102 or other computing devices used by the remote students (or those physically present in the classroom); and a network-connectivity infrastructure 107 (called Mega Vision™ in preferred embodiments) that provides network-connectivity services between the Escribano™ intelligent video board 103 and the remote tablet computers 101, 102 (or those physically present in the classroom); all connected through the public Internet 105, private network, or public or private cloud. The Mega Vision™ network-connectivity infrastructure 107 typically includes one or more web-connectivity servers 108 (e.g., Apache Web Servers) that host a remote-connectivity application (called Mega Meetings™ in preferred embodiments), as well as real-time connectivity and interactive connectivity establishment (ICE) servers 104 (such as node.js servers hosting EasyRTC™ and ICE web applications). These services typically work with a cloud-based audio-visual communication service 109 (such as that provided by Twilio™) to effect audio-visual communication between the physical classroom and remote students.

The Escribano™ intelligent video board 103 and Mega Vision™ network-connectivity infrastructure 107 (including the Mega Meetings™ service described below) together solve the problems students face when they cannot attend school for reasons such as chronic medical conditions, temporary illness, or travel. Within the virtual classroom created by the teacher with the Escribano™ intelligent video board, remote students are able to participate fully in classroom activities by, e.g., engaging in live audio-visual conversation with the teacher and students in the physical classroom, “raising a hand” to send a request or to send data to the teacher, watching a live lecture, receiving live data written or drawn on the intelligent video board by the teacher or classmates, contributing to whiteboard interaction with writings or drawings of their own, receiving and sharing electronic documents and screenshots, and sharing their screens with the physical classroom. The teacher also has the option to limit remote students only to viewing a shared screen or to allow their active participation in class through drawing tools and other tools (such as video chat, text chat and screen sharing) that enable sharing of information and ideas from the remote students to those in the physical classroom. A socket I/O server 106 residing with the Escribano™ intelligent video board 103 enables the intelligent video board 103 to establish connections with multiple remote or physically present users at once through the Mega Vision™ network infrastructure 107.

Operation of the Escribano™ intelligent video board 103 is controlled by the proprietary Miros™ brand control software (described below). The intelligent video board 103 is an interactive device that utilizes touchscreen technology, responsive to both physical human touch and to an input stylus, to capture, display, and share data written or drawn freeform on the board's surface. The intelligent video board 103 is configured under normal operation to auto-save (at very short intervals) the current status of the board (including any images and writings on the screen at the time of the auto-save), to allow retrieval of previously saved statuses and images, to select from among a variety of drawing and text tools, and to link to remote devices such as servers and other intelligent boards, including remote student devices. The intelligent board may also capture audio to save with the current session or to transmit to a remote device. Certain embodiments also have a camera to create video files and to provide for real-time transmission of live video.

The intelligent video board 103 uses standard touch-screen, or multi-touch, technology to allow instructors and students to write, erase, and navigate using their fingers or a “magic pen” input stylus. The teacher or students in the physical classroom can draw and write on the intelligent board 103 and keep the data on the board up for display in the physical classroom as well as share it with the tablet computers 101, 102 used by remote or physically present students. The touch-sensitive display allows the teacher and students to make diagrams, draw shapes, and perform just about any drawing-related activity. Additionally, when the intelligent video board 103 is powered off, its display screen can be used as a traditional blackboard to allow writing with dry-erase markers.

The intelligent video board 103 is configured to create and send real-time system-status reports to and allow live monitoring by remote technical-support systems and personnel to ensure proper system performance and efficient usage of system resources, such as processing power, memory, storage, etc. The intelligent video board 103 also is equipped with functionality to allow the teacher to cede control of the board's operation to remote technical-support personnel for diagnostic and trouble-shooting purposes. Status-monitoring and live-monitoring services are supported by industry-standard IT products such as the Nagios™ open-source system-monitoring application and server suite. Live remote technical support is provided through an IT-support gateway under the brand-name Guacamole™.

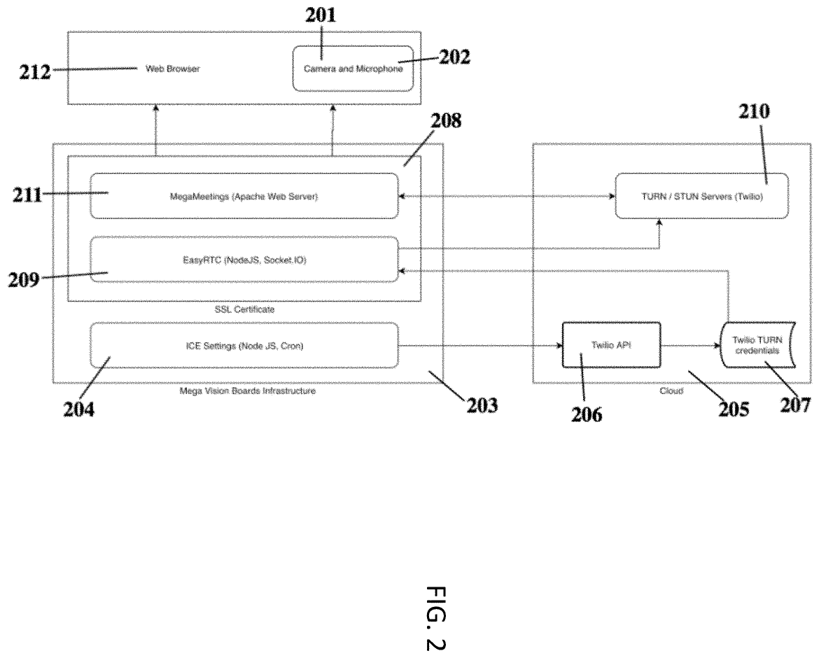

FIG. 2 shows the interconnectivity of user devices (i.e., the Escribano™ intelligent video board and remote tablet computers) through a virtual classroom supported by the Mega Vision™ network infrastructure 203 (also labeled 107 in FIG. 1). In the Internet-based implementation shown here, the Mega Vision™ infrastructure 203 includes the Mega Meetings™ remote-connectivity service, which allows students in the physical classroom and in remote locations to communicate with each other through the web cams 201, microphones 202, and web browsers 212 of their respective devices. The servers of the Mega Vision™ infrastructure 203 must be able to respond to web requests and, in this embodiment, the system employs an Apache Web Server back-end hosting the Mega Meetings™ service in combination with one or more node.js servers that enable use of open-source WebRTC real-time communication tools through the EasyRTC framework. To this end, the Mega Vision™ network infrastructure 203 includes a Secure Sockets Layer (SSL) 208 that comprises both an EasyRTC server 209 (NodeJS) and a Mega Meetings™ server 211 (Apache Web). The web-browser applications 212, cameras 201, and microphones 202 of the user devices all establish connections with the Secure Sockets Layer (SSL) 208 to enable participation in the virtual classroom.

To enable the virtual classroom, an Interactive Connectivity Establishment (ICE) server 204 (NodeJS) in the Mega Vision™ network infrastructure 203 calls an application programming interface (API) component 206 of a Twilio cloud-based communication service 205. The Twilio server 205 responds by providing TURN credentials 207 to the SSL 208, which is used to enable secure communication between the web browser and web server. Within the SSL 208, the EasyRTC server 209 receives the credential information, processes it, and forwards it to TURN/STUN servers 210 in the Twilio cloud server 205, which then establish audio, video, and web-browser communication among the virtual classroom devices. Once a secure connection is established, the Twilio communication service 205 and the Mega Meetings™ server 211 enable the communication between remote students and physical classroom.

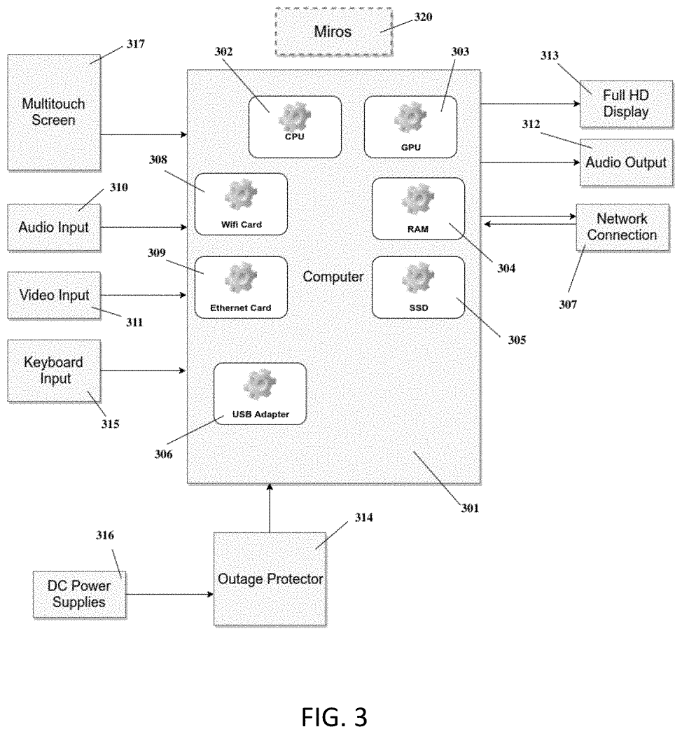

FIG. 3 shows the connectivity among key components of the Escribano™ intelligent video board. Many of these components are also found in the tablet computers or other devices used by remote or physically present students. The Escribano™ intelligent board is a specialized, interactive computing system that includes a central computing unit 301 (such as a motherboard) at its heart. The central computing unit 301 includes a central processing unit (CPU) 302 that operates under control the Miros™ control program 320, which forms a set of instructions stored to one or more physical devices (non-volatile memory, SDD, hard disk drive, etc.) for retrieval and execution by the CPU 302.

The central computing unit 301 also typically includes a graphics processing unit (GPU) 303 to drive fluid, real-time display of video content to a video-output device 313 (e.g., a high-definition (HD) video display which, in preferred embodiments, is a component of the multitouch display); a volatile random access memory (RAM) storage unit 304; a solid-state disk (SSD) drive 305 or other non-volatile storage unit; a USB adapter 306 (or other serial communication device) for data communication; and a WiFi card 308 and/or Ethernet card 309 to enable network connectivity 307. The intelligent video board also includes a multitouch screen 317; an audio-input device 310 (e.g., a microphone) and audio-output device 312 (e.g., a speaker); a video-input device 311 (e.g., a camera) and the video-output device 313; a keyboard 315 or other textual input device; and an AC/DC power supply 316 coupled to a surge or outage protector 314.

In preferred embodiments, for ease of use with all users (but especially younger students), the intelligent board a uses the multitouch screen 317 as the primary source of direct input from users, allowing the users to provide input with the touch of their fingers or a pen-like device, instead of requiring use of a mouse or other input device that requires more complex manipulation by the user. Common tools for interaction with a multi-touch screen include a simple pen that casts a shadow on an infrared screen or a stylus that inputs voltage to a capacitive screen.

In some embodiments, the Miros™ software is configured to enable a wide variety of functions, including creating a user account; restarting and shutting down the system; drawing in the multi-touch display from different digital styles; choosing the width of the digital stroke shown on the display; choosing among a variety of colors; saving work done in an editable format; saving the contents of the display board to a variety of formats, such as PDF; printing the workspace content; using a variety of drawing tools, such as digital erasers and shape makers; and loading documents onto the screen, such as PDF, Excel, and a variety of other document types. The user also can create a new project or a new workspace. The user can also load images, videos, and audio into the display, as well as send emails and send and receive live drawings from other users in the same session.

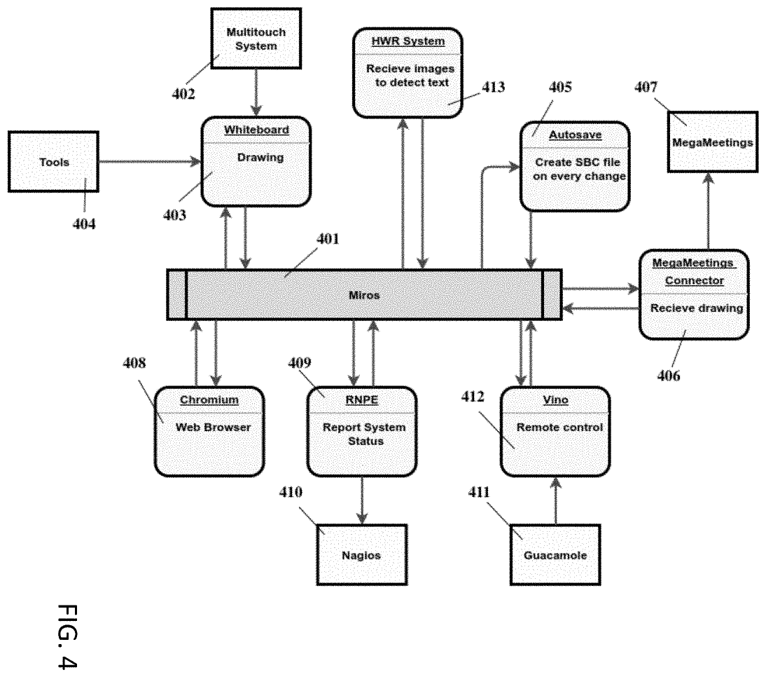

FIG. 4 shows the flow of data as the Miros™ software 401 operates the various functions of the intelligent board. The Miros™ software 401 communicates with web browsers to send and receive data to other networked devices. The software includes a reporting system, in which a variety of system health, status, and performance data (temperature data, memory-usage data, etc.) is delivered from the intelligent board to a support server. The Miros™ software 401 is also configured to allow a remote server to gain control of the intelligent video board and remotely control the device, e.g., in situations where technical support is needed.

The multitouch display system 402 of the intelligent video board is connected to a whiteboard 403 component of the Miros™ software 401. The user can draw in the whiteboard using different tools 404, such as digital markers, erasers, and geometric shapes, through the multitouch display interface. The Miros™ software 401 can receive data of the drawings in the whiteboard 403 and also send data to the whiteboard 403 to have it displayed. The Miros™ software 401 can also receive images from a hand-writing recognition (HWR) system 413 and detect text in the images received.

The Miros™ software 401 has an autosave feature 405, which creates a .sbc file on every change or at periodic intervals. The Miros™ software 401 can also establish a Mega Meetings™ connection 406 and communicate with other users 407 in the Mega Meetings™ session to share and transfer information. The Miros™ software 401 also has access to a web browser 408, such as Chromium, but it can also use other browsers.

The Miros™ software 401 implements a report-system status component 409, which sends monitoring information to a Nagios™ technical-support server 410. Through the Nagios™ server 410, the CPU, hard drive, memory, and other system components are monitored remotely. Through the Guacamole™ support server 411 and the Miros™ software's remote-control component 412, operation of the intelligent video board can be controlled remotely through a virtual private network. This live monitoring allows teachers to focus on teaching as the intelligent video board reports automatically its live performance to a technical support center. Processing power, memory, and storage capacity needs are all calculated in real time. The Miros™ software 401 has the capabilities to control and interconnect different functions to make it easy for the user to interact with the computer and do different classroom tasks. It also is continuously monitored by the HelpDesk Service, and is ready for secure authorized remote assistance.

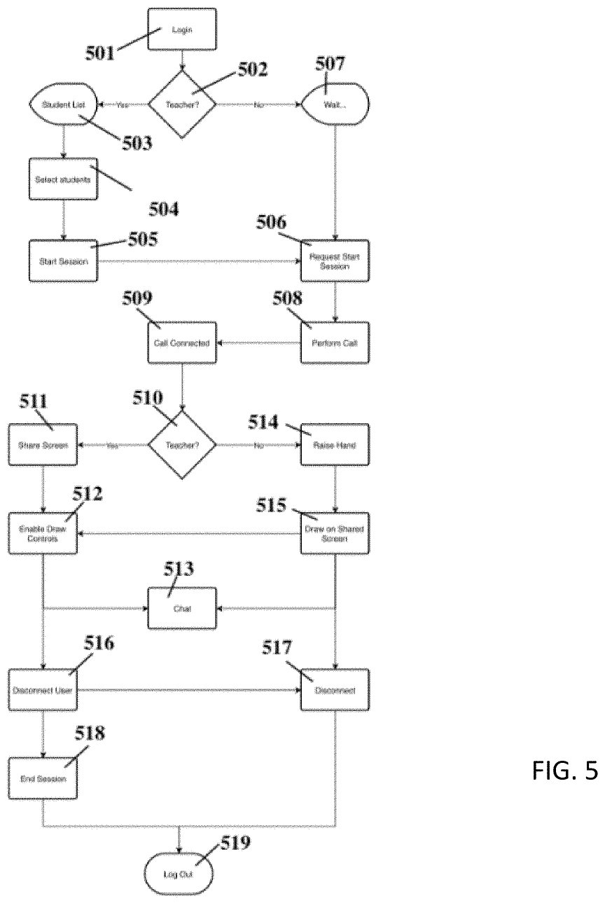

FIG. 5 shows the flow within the Mega Meetings™ service, working in conjunction with the Miros™ software of the Escribano™ intelligent video board or the web browser application of the remote device, as it hosts a virtual classroom and drives interaction between the physical classroom and remote students. Once a Mega Meetings™ connection is established between the intelligent board in the classroom or the remote student's device, the teacher can share the screen, draw on the screen, or chat with the students who established the connection. Upon a login by the teacher or remote student or parent (step 501), the system assesses whether the user logging in is a teacher (step 502). If so, the teacher is presented with a list of students (step 503) and is able to select students for the session (step 504) and start the session (step 505). The system then sends a “Start Session” requests to invited participants (step 506) to non-teachers, such as students. If, upon login, the user logging in is not a teacher, the user is placed in wait mode (step 507) until the “Start Session” request arrives.

Once a session is started, when a user wishes to interact with others in the virtual classroom, the user performs a call (step 508), and the system connects the user (step 509). The system assesses if the requesting user is a teacher (step 510) and, if so, gives the teacher the option to share the screen (step 511), enable draw controls (step 512), and chat with other users (step 513). If the user is nota teacher, the user is given the option to raise their hand (step 514) and request access to draw on the shared screen using the draw controls (step 515). Once the drawing task is performed, the teacher can disconnect the user from the drawing controls (step 516). Furthermore, if the teacher or student user so desires, they can disconnect from the session (step 517) and log out (step 518). The teacher can also disconnect a student if desired. Lastly, the teacher can end the session upon choosing to do so (step 519). When using Mega Meetings™ to connect to a call, the server has to validate which role the user has. It will connect the call depending on whether the user is a student or teacher.

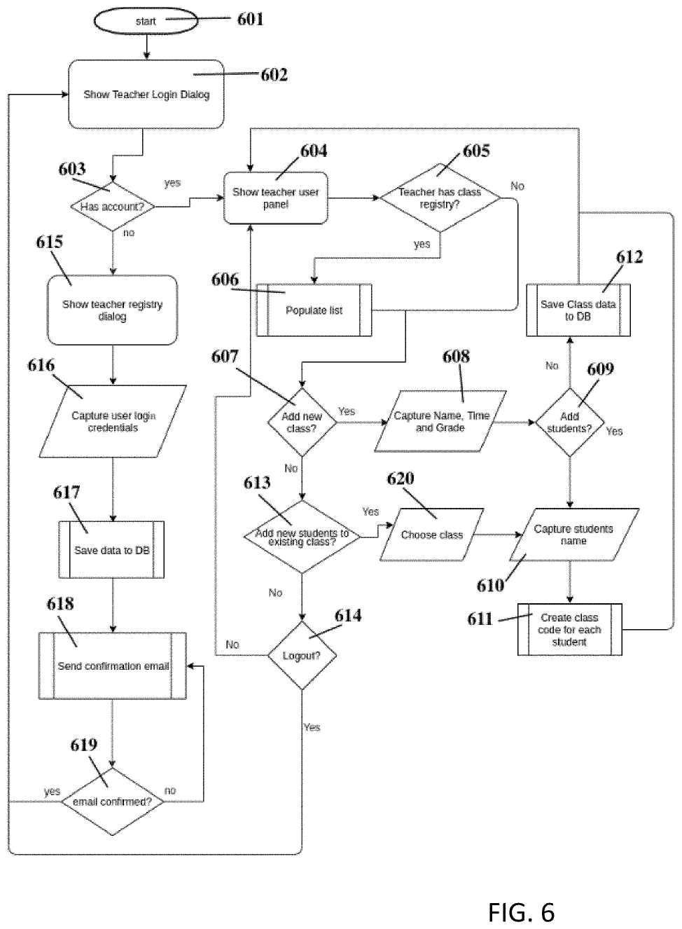

FIG. 6 shows the flow within the intelligent board, under control of the Miros™ software, to allow the user (i.e., a teacher or authorized classroom representative) to create and connect to a virtual classroom. Upon start up (step 601), the system presents a login dialogue to the user (step 602) and, upon receiving input from the user (in the form of login credentials or a request to create an account), assesses whether the user has a valid account (step 603). If so, the system displays a teacher-specific user-interface panel (step 604) and assesses whether the user has previously created a class registry (step 605). If so, the system populates the user-interface panel with the user's class registry (step 606), which the user then can use to establish a virtual classroom for the desired class.

Without regard to whether the user has previously created a class registry, the system displays a prompt that allows the user to create a new class and save it in a class registry (step 607). If the user elects to create a new class, the system prompts the user to input description information about the class, such as class name, grade level, and class meeting time (step 608). The system then prompts the user to add students to the class (step 609). If the user opts not to add students at this time, the system stores the newly created class in the user's class-registry database (step 612).

If the user opts at step 607 not to create a new class at this time, the system displays a prompt that allows the user to add students to an existing class (step 613). If the user elects to add new students, the system prompts the user to select the appropriate class from a list of classes in the user's class registry (step 620). At this point, or if the user has opted to add new students to a newly created class at step 609 above, the system prompts the user to enter the names of all students to be added to the class and capture the students' names (step 610). The system then creates class codes linking each added student's name to the corresponding class (step 611) and saves the class to the user's class-registry database (step 612).

If the user chooses not to add a new class (step 607) or add new students to an existing class (step 613), the system gives the user an option to logout and return to the login dialogue or remain logged in and return to the teacher-specific interface panel (step 614).

If the system assess at step 603 that the user does not have a valid account, the system presents a user-registry dialog (step 615) that prompts the user to create login credentials. The system captures the login credentials (step 616), saves this data (step 617), sends a confirmation email asking the user to confirm the creation of a new account (step 618), and then awaits confirmation (step 619). Once the user has confirmed the new account, the system directs the user back to the login dialog. If the new account is not confirmed, the system in some embodiments will send another confirmation email or give the user the opportunity to request a new confirmation email.

Once a teacher or other classroom representative has logged into the Escribano™ intelligent video board, the intelligent video board communicates with the Mega Meetings™ service to maintain and access the registry of classes and students assigned to each class. The Mega Meetings™ service allows the Escribano™ intelligent board to connect a student to a class being conduct on the intelligent board.

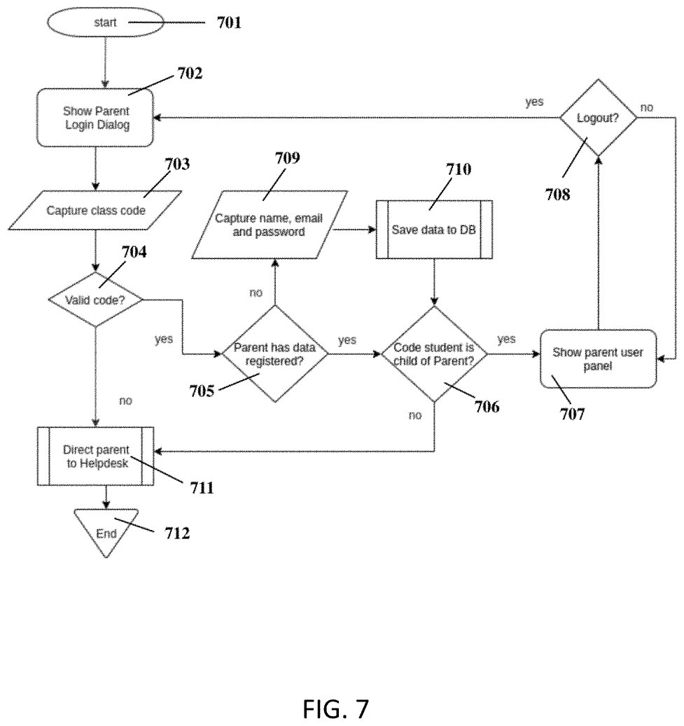

FIG. 7 shows the flow of a Mega Meetings™ session as the parent/guardian of a remote student establishes a connection to the virtual classroom. Mega Meetings™ allows the parent/guardian to authorize class calls and follow the student's progress. A technical-support helpdesk is always available to assist the user if any trouble arises during the process.

Upon initiation of a connection with the Mega Meetings™ service through the web browser the parent/guardian computer (step 701), the Mega Meetings™ service presents the user with a parent login dialog interface (step 702) and prompts the user for the class code corresponding to a student registered to a virtual classroom (step 703). If the code is valid (step 704), the system assesses whether the parent has credential data registered for that virtual classroom (step 705). If no credential data is registered, the system prompts the user to enter a name, email, and password (step 709) and stores that data to a database corresponding to the virtual classroom (step 710).

Upon confirming or capturing the user's credential data, the Mega Meetings™ service uses the credential data provided to assess whether the user is in fact the parent or guardian of the student connected to the code provided (step 706). If the code and credential data do not match, the user is directed to the parent helpdesk for assistance (step 711) and the Mega Meetings™ session ends (step 712). If the code and credential data do match, a parent-user interface panel is displayed in the user's web browser (step 707) and the user is able to monitor the virtual classroom activity of the student. When the virtual classroom activities are concluded, or at other any time chosen by the user, the user can logout of the session (step 708), at which point the user is returned to the parent login dialog interface.

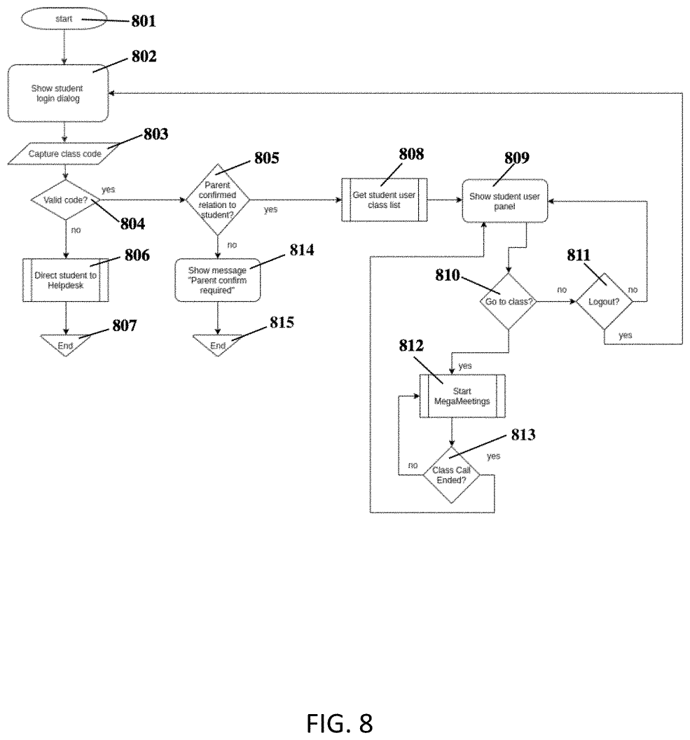

FIG. 8 shows the flow of a Mega Meetings™ session as a remote or physically present student establishes a connection to the virtual classroom. Mega Meetings™ ensures that the student has a registered parent/guardian in the database before allowing the student to connect to the classroom.

Upon initiation of a connection with the Mega Meetings™ service through the web browser the student's computer (step 801), the Mega Meetings™ service presents the student with a student login dialog interface (step 802) The Mega Meetings™ service then prompts the student to enter the class code assigned to the student (step 803) and assesses whether the code entered is a valid code (step 804). If the student has not entered a valid class code, the student is directed to the helpdesk (step 806) and the Mega Meetings™ session is terminated (step 807).

If the class code provided by the student is valid, the system assesses whether the student's parent/guardian (or classroom teacher for students physically present in the classroom) has confirmed relation to the student per the process of FIG. 7 (step 805). If the parent/guardian has not confirmed relation, the system presents the student with a “Parent confirmation required” message (step 814) and terminates the session (step 815).

If the student has entered a valid code and the parent/guardian has confirmed relation to the student, the Mega Meetings™ service retrieves a list of classes to which the student user is registered (step 808) and then displays the list in a student user panel in the user's web browser application (step 809). Through the student user panel, the student is prompted to select a classroom to join (step 810), and Mega Meetings™ connects the student to the virtual classroom for the selected class (step 812). The student remains in the virtual classroom until the virtual classroom session is terminated (step 813), at which point the student is returned to the student user panel (step 809).

At any point while in the student user panel, the student may opt to logout (step 811). Upon logging out, the student is returned to the student login dialogue interface (step 802).

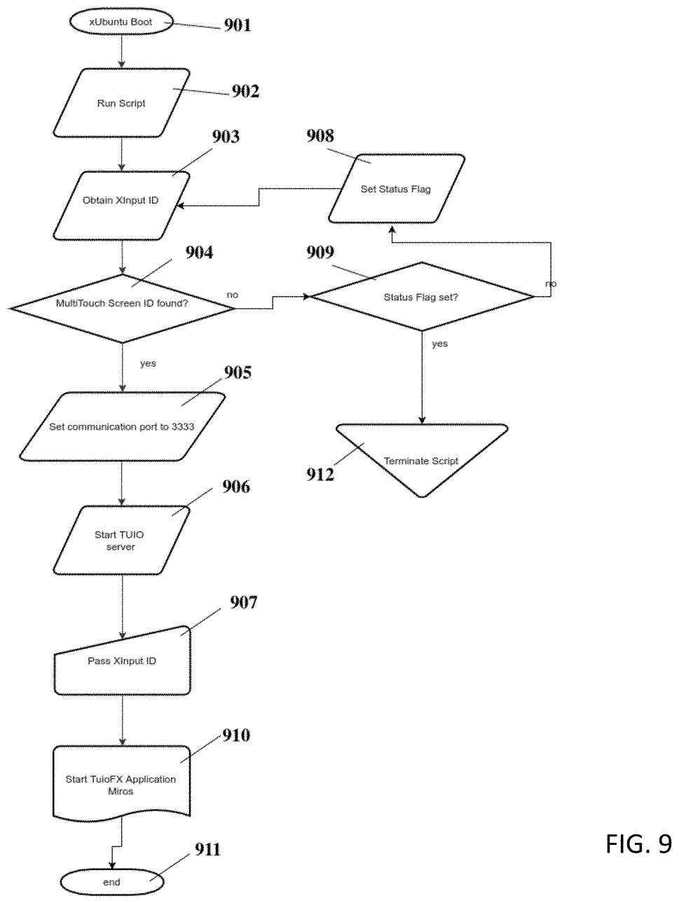

FIG. 9 is a flow diagram showing the boot up process of the intelligent video board. In currently preferred embodiments, the Miros™ control software runs on the xUbuntu operating system. Upon startup, the intelligent board runs any scripts needed to configure the operating system and the central computer. To run Escribano™ system on Miros™, the TUIO protocol can be used to start the multitouch communication between the screen and the computer. Upon initialization of the xUbuntu operating system, an identification string is assigned to the multitouch device. The identification string is then used to communicate with a TUIO server through port 3333.

In carrying out the boot-up process, an xUbuntu boot is first performed (step 901). A boot-up script is then run (step 902) and an Xinput ID obtained (step 903). The system then assess whether a multitouch screen ID exists (step 904) and, if so, sets the communication port to 3333 (step 905). The system then starts the TUIO server (step 906), which passes the Xinput ID (step 907) and starts the Miros™ application (step 910) which, in preferred embodiments, is a TUIOFX application. The boot-up process then ends (step 911).

If no multitouch screen ID is found at step 904, the system assesses whether a “status” flag has previously been set (step 909). If so, the system terminates the boot-up script (step 913). If the status flag has not previously been set, the system sets it now (step 908) and then loops back to again obtain the Xinput ID (step 903) and search again for a multitouch screen ID (step 904).

While the invention has been described here in terms one or more preferred embodiments, it will be apparent to those skilled in the art that various changes and modifications can be made to those embodiments, and other embodiments altogether can be used to carry out the invention, without departing from the scope and spirit of the invention.

What is claimed is:

1. An interactive video board for use in effecting a virtual classroom that enables real-time audio-visual communication and a real-time exchange of digital information between students in a physical classroom and a remote student at a location outside the physical classroom, the interactive video board comprising:
a central processing unit (CPU);
a physical storage device coupled to the CPU and storing machine-executable instructions which, when executed by the CPU, cause the CPU to control operation of the interactive video board;
a multitouch display device operating under control of the CPU and comprising both:
a video display device configured to present graphical information to the students in the physical classroom; and
a multitouch input screen configured to capture, in response to a student's touching the screen, graphical input data for display on the video display device in the physical classroom and on a remote device used by the remote student;
audio and video capture devices operating under control of the CPU and configured to create audio and video data from activities in the physical classroom for delivery to the remote device; and
a remote-connectivity component operating under control of the CPU and coupled to an external network to effect delivery of the graphical input data and the audio and video data from the interactive video board to the remote device.

2. The interactive video board of claim 1, further comprising a system-monitoring component operating under control of the CPU and configured to collect data about operation of interactive video board components for delivery to an external system monitoring service.

3. The interactive video board of claim 1, further comprising a remote-control component operating under control of the CPU and configured to allow a user of the interactive video board to cede operational control of the interactive video board to a remote technical-support service.

4. The interactive video board of claim 1, where the remote connectivity component device is also configured to receive from the remote device additional graphical input data created by the remote student and deliver the additional graphical input data for display by the video display device in the physical classroom.

5. The interactive video board of claim 1, further comprising an audio output device, and where the remote connectivity component device is also configured to receive from the remote device additional audio and video data captured by the remote device and deliver the additional audio and video data for display by the video display and the audio output device in the physical classroom.
